(19) United States
(12) Patent Application Publication
(10) Pub. No.: US 2006/0243388 A1
(43) Pub. Date: Nov. 2, 2006

(54) Under roof peel and stick tile underlayment

(75) Inventors: Mira Kubiak, Haledon, NJ (US); Adem Chich, Kearny, NJ (US)

Correspondence Address: Attn: William J. Davis, Esq.;GAF MATERIALS CORPORATION, Building No. 8-2, Legal Department, 1361 Alps Road, Wayne, NJ, 07470, US

(73) Assignee: BUILDING MATERIALS INVESTMENT CORPORATION

(21) Appl. No.: 11/413,901

(22) Filed: Apr. 28, 2006

Related U.S. Application Data
(60) Provisional application No. 60/675,780, filed on Apr. 28, 2005.

(51) Int. Cl. B32B 37/00

(52) U.S. Cl. 156/324; 156/289; 428/41.8

(57) ABSTRACT

An under roof peel-and-stick tile underlayment, having a core or substrate having an upper and lower surface. On the lower surface of the substrate, an adhesive compound is layered and then covered with a release liner. On the selvage edge of the upper surface of the substrate, an adhesive coating is layered and then covered with a top release liner. After the underlayment is adhered to a roof surface, ceramic tiles, such as Spanish-style tiles are adhered on the upper surface.

### RELATED APPLICATIONS

This application claims the benefit of U.S. Provisional Application No. 60/675,780, filed Apr. 28, 2005, the entire content of which is incorporated by reference herein in its entirety.

### FIELD OF THE INVENTION

The present invention relates to roofing membranes. More specifically, the present invention relates to an under roof peel-and-stick tile underlayment which provides a water-tight layer thereon on a roof surface and which prevents slippage by a roofer working on the roof surface.

### BACKGROUND OF THE INVENTION

Roofing underlayment is generally an asphalt-saturated felt or other sheet material (may be self-adhering) installed between the roof deck and the roof covering, usually used in a steep-slope roof construction. Underlayment is primarily used to separate the roof covering from the roof deck, to shed water and to provide secondary weather protection for the roof area of the building. Oftentimes, shingles or tiles are then applied upon the underlayment.

Numerous underlayments presently in the marketplace include many layers of coatings and adhesives on a substrate. Currently, roofing membranes and underlayments are adhered to roof decks or insulation boards utilizing a variety of methods. One such method involves the use of liquid based adhesives that employ natural and/or synthetic elastomers and resins in organic solvent systems. These liquid based adhesives do not always provide good bond strength and long-term durability. For example, if conditions during application are windy, dust or other debris may adhere to the adhesive and impair the quality of the bond. High temperatures may cause the adhesive to dry out too quickly. These environmental problems may complicate installation procedures. Additionally, liquid based adhesives often utilize organic solvents such as toluene and xylene. These solvents pose a health and fire hazard, and their use is undesirable.

Other methods of adhering roofing membranes include the use of slow drying water based adhesives. Additionally, asphalt based adhesives that must be heated to a molten state and then swabbed onto the roofing surface may also be used. However, these asphalt adhesives require special equipment and can pose a fire risk. Heat welding of thermoplastic materials and nailing have also been utilized to secure roofing membranes or underlayments to roof decks or insulation boards. Cover strips, flashings or other accessories have also been secured utilizing these processes. These processes may be extremely time consuming, hazardous or provide an inferior seam.

### SUMMARY OF THE INVENTION

This invention relates generally to bituminous roofing adapted for the waterproofing and sealing of substrate structures and to the method of manufacturing such materials. More particularly, the present invention is in the field of roofing membranes and shingles, having a factory-applied self-adhesive layer on the bottom surface and a thermoplastic modifier such as atactic polypropylene modified bituminous compound on the top surface in order to provide easy and hassle-free field application by roofing personnel.

The present invention relates a self-adhering roofing tile underlayment having a minimum of coatings on a substrate. The underlayment according to the present invention comprises a substrate having a lower surface and an upper surface, the upper surface having a selvage edge upon which a compound is applied and having a removable release liner on the compound. A self-stick compound is applied on the lower surface of the substrate.

The preparation of the membrane in accordance with the present invention comprises the steps of pre-priming the side lap of a single-ply membrane, pre-coating the side lap with an adhesive material, applying a release liner on the adhesive material, and rolling the membrane for storage and later application on a roof substrate.

The above and other features of the invention, including various novel details of construction and combinations of parts, will now be more particularly described with reference to the accompanying drawings and pointed out in the claims. It will be understood that the particular device embodying the invention is shown by way of illustration only and not as a limitation of the invention. The principles and features of this invention may be employed in various and numerous embodiments without departing from the scope of the invention.

### BRIEF DESCRIPTION OF THE FIGURE

These and other features, aspects, and advantages of the apparatus and methods of the present invention will become better understood with regard to the following description, appended claims, and accompanying drawings where:

FIG. 1 is a schematic side view of one embodiment of the membrane in accordance with the present invention.

### DETAILED DESCRIPTION

As used herein, the term “selvage edge” generally refers to an edge designed for certain sheet good materials, e.g., mineral-surfaced sheets. With mineral surfaced sheets, the surfacing is omitted over a portion of the longitudinal edge of the sheet (e.g., mineral surface cap sheet) in order to obtain better adhesion of the overlapping sheet.

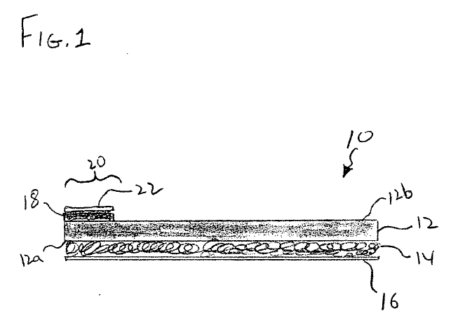

FIG. 1 is a schematic representation of the layers of the non-asphaltic membrane in accordance with one embodiment of the present invention. In FIG. 1, underlayment sheet 10 includes substrate 12 having a deck side 12a, which is the lower surface of substrate 12 that is applied on a roof substrate (not shown), and a weather side 12b on the opposite side of membrane 12, and which is the upper surface of substrate 12 that is exposed to the environment when deck side 12a of membrane 12 is applied to a roof substrate. An adhesive layer 14 is coated on deck side 12a of membrane 12. Adhesive layer 14 is preferably a self-stick compound. Optionally, a release liner 16 is placed upon adhesive layer 14. When sheet 10 is to be applied to a roof substrate, release liner 20 is peeled off adhesive layer 18. Sheet 10 is then positioned on the roof substrate and is adhered thereto by adhesive layer 18. This type of sheet is thus commonly referred to as a “peel and stick” membrane.

The border/edge of membrane 12 is commonly earmarked as the selvage edge 20. Selvage edge 20 generally is in the range of approximately 1 inch to 6 inches in width and typically extends along the entire longitudinal length of the membrane. As explained hereinabove, selvage edge generally refers to an edge designed for certain sheet good materials, e.g., mineral-surfaced sheets. On most selvage edges, the surfacing is omitted over a portion of the longitudinal edge of the sheet (e.g., mineral surface cap sheet) in order to obtain better adhesion of the overlapping sheet.

In accordance with the present invention, a compound 18, which may include an adhesive, is coated on selvage edge 20. A selvage edge release liner 22 is applied upon compound 18 on selvage edge 20.

In all of the embodiments in accordance with the present invention, substrate 12 is preferably a water impermeable woven or non-woven fibrous mater or thermoplastic single-ply membrane, though the invention is not limited in this regard. Substrate 12 may be modified bitumen or thermoset or thermoplastic membrane preferably polyvinyl chloride (PVC) and other resinous compositions containing polyvinyl chloride, chlorosulfonated polyethylene (CSPE or CSM), chlorinated polyethylene (CPE), ethylene propylene diene terpolymer (EPDM), APP modified bitumen, SBS modified bitumen, or a thermoplastic olefin (TPO).

In preparing sheet 10 in accordance with the described embodiments, a long strip of membrane 12 is extended along a surface. A selvage edge 20 is defined on weather side 12b of substrate 12. Selvage edge 20 is then coated with an adhesive compound 18. Selvage edge release liner 22 is then placed on compound 18. Underlayment 10 is then rolled for storage and later application on a roof substrate.

Prior to placement on a roof surface, lower release liner 16 is removed as the roll is unwound such that adhesive layer 14 on deck surface 12b of substrate 12 adheres to the roof surface (not shown). After a first roll is adhered to a roof surface, release liner 22 on the selvage edge 20 on the weather side 12b of substrate 12 is removed so as to expose adhesive compound 18. A second roll of underlayment is then positioned on the roof such that the bottom surface of the second roll adheres in part to the selvage edge of the first roll of underlayment to create a water tight seal between the rolls on the roof surface. Subsequent rolls will be adhered to the roof surface in the same manner until the entire roof surface is covered.

Weather side 12b of the substrate 12 is provided with a skid resistant surface to prevent slippage by roofers when applying the underlayment 10 or when working on a roof surface. Ceramic tiles, such as Spanish-style tiles may be adhered on weather side 12b of substrate 12.

Adhesive layer 14 on deck side 12a of substrate 12 and adhesive compound 18 on selvage edge 20 may be any adhesive or glue commonly used in the roofing industry for applying membranes to a roof substrate. Nonlimiting examples of adhesives include, but are not limited to, polyurethane, ethylene-butylene-styrene, a butyl compound or other waterproofing compound such as single component PVAc (polyvinyl acetate) water-resistant adhesive, water-resistant polyvinyl acetate adhesive, EVA (ethylene vinyl acetate)-hot melt adhesives, pressure sensitive hot melt adhesive atactic polypropylene (APP) base pressure sensitive tapes, polyurethane adhesives, thermoplastic adhesive film based with co-polyamides, thermoplastic adhesive film based with mixed polyolefin and co-polyamide, animal base adhesive, asphaltic base adhesive styrol or verstat acrylate types, neoprene rubber cementic base adhesive.

Release liner 26 may be any suitable release liner material such as waxed paper, polycoated paper, film based paper or plastic. Release liner may optionally be treated with a release agent, such as but not limited to, silicone, a fluorocarbon polymer such as TEFLON or some other release agent with non-sticking properties that enables the release liner to be easily peeled away from the adhesive composition.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A self-adhering roofing tile underlayment membrane comprising:
a. a substrate having a deck side and a weather side, the weather side having a selvage edge area defined along a longitudinal edge of the substrate;
b. an adhesive layer coated on the deck surface of the substrate;
c. an adhesive compound coated on the selvage edge; and
d. release liners applied on the adhesive layer and adhesive compound.

2. The membrane as recited in claim 1, wherein the selvage edge has dimensions on the range of from approximately 1 inch to 6 inches in width.

3. The membrane as recited in claim 1, wherein the substrate is a single-ply membrane.

4. The membrane as recited in claim 3, wherein the single-ply membrane is selected from the group consisting of: modified bitumen or thermoset or thermoplastic membrane preferably polyvinyl chloride (PVC) and other resinous compositions containing polyvinyl chloride, chlorosulfonated polyethylene (CSPE or CSM), chlorinated polyethylene (CPE), ethylene propylene diene terpolymer (EPDM), APP modified bitumen, SBS modified bitumen, or a thermoplastic olefin (TPO).

5. The membrane as recited in claim 1, wherein the adhesive is selected from the group consisting of: polyurethane, ethylene-butylene-styrene, a butyl compound or other waterproofing compound such as single component PVAc (polyvinyl acetate) water-resistant adhesive, water-resistant polyvinyl acetate adhesive, EVA (ethylene vinyl acetate)-hot melt adhesives, pressure sensitive hot melt adhesive atactic polypropylene (APP) base pressure sensitive tapes, polyurethane adhesives, thermoplastic adhesive film based with co-polyamides, thermoplastic adhesive film based with mixed polyolefin and co-polyamide, animal base adhesive, asphaltic base adhesive styrol or verstat acrylate types, neoprene rubber cementic base adhesive.

6. The membrane as recited in claim 1, further comprising a primer and/or cleaner applied on the substrate, the primer and/or cleaner is selected from the group consisting of heptanes, toluene, methyl alcohol, hexane, xylene, diphenylmethane diisocyanate, polymethylene polyphenol isocyanate, ethylbenzene, naphtha, hydrocarbon resins or halogenated butyl.

7. The membrane as recited in claim 1, wherein the release liner is paper, polycoated or film-based.

8. The membrane as recited in claim 6, wherein the release liner is treated with a release agent.

9. The membrane as recite din claim 7, wherein the release agent is selected from the group consisting of: silicone, a fluorocarbon polymer such as TEFLON or a release agent with non-sticking properties that enables the release liner to be easily peeled away from the adhesive composition.

10. A method of preparing a self-adhering roofing membrane, the method comprising the steps of:
a. providing a length of a substrate membrane;
b. pre-coating one surface with an adhesive material;
c. applying a release liner on the adhesive material;
d. coating a selvage edge of the opposite side of the membrane with an adhesive material;
e. applying a release line on the adhesive material on the selvage edge, and
f. rolling the membrane for storage and later application on a roof substrate.

11. The method as recited in claim 9, wherein the adhesive material in steps b and d may be the same or a compatible adhesive applied on other parts of the membrane.

12. The method as recited in claim 11, wherein the adhesive is selected from the group consisting of: polyurethane, ethylene-butylene-styrene, a butyl compound or other waterproofing compound such as single component PVAc (polyvinyl acetate) water-resistant adhesive, water-resistant polyvinyl acetate adhesive, EVA (ethylene vinyl acetate)-hot melt adhesives, pressure sensitive hot melt adhesive atactic polypropylene (APP) base pressure sensitive tapes, polyurethane adhesives, thermoplastic adhesive film based with co-polyamides, thermoplastic adhesive film based with mixed polyolefin and co-polyamide, animal base adhesive, asphaltic base adhesive styrol or verstat acrylate types, neoprene rubber cementic base adhesive.

13. The method as recited in claim 10, wherein the substrate is a single-ply membrane.

14. The membrane as recited in claim 12, wherein the single-ply membrane is selected from the group consisting of: modified bitumen or thermoset or thermoplastic membrane preferably polyvinyl chloride (PVC) and other resinous compositions containing polyvinyl chloride, chlorosulfonated polyethylene (CSPE or CSM), chlorinated polyethylene (CPE), ethylene propylene diene terpolymer (EPDM), APP modified bitumen, SBS modified bitumen, or a thermoplastic olefin (TPO).

15. The method as recited in claim 9, wherein the release liner is paper, polycoated or film-based.

16. The membrane as recited in claim 15, wherein the release liner is treated with a release agent.

17. The membrane as recited in claim 16, wherein the release agent is selected from the group consisting of: silicone, a fluorocarbon polymer such as TEFLON or a release agent with non-sticking properties that enables the release liner to be easily peeled away from the adhesive composition.
